(19) United States
(12) Patent Application Publication
(10) Pub. No.: US 2023/0243922 A1
(43) Pub. Date: Aug. 3, 2023

(54) VEHICLE EXTERIOR COMPONENT

(71) Applicant: TOYODA GOSEI CO., LTD., Kiyosu-shi (JP)

(72) Inventor: Kozo HIROTANI, Kiyosu-shi (JP)

(21) Appl. No.: 18/145,617

(22) Filed: Dec. 22, 2022

(30) Foreign Application Priority Data
Jan. 28, 2022 (JP) 2022-011600

(51) Int. Cl. G01S 7/40; G01S 7/02; H05B 3/16

(52) U.S. Cl. CPC G01S 7/4047; G01S 7/027; H05B 3/16; H05B 2214/02; H05B 2203/003

(57) ABSTRACT

A vehicle exterior component includes a decoration body and a heater wire that includes a first heater wire portion arranged inside a passage region for millimeter waves in an up-down direction and a second heater wire portion arranged outside the passage region and extending horizontally on at least one of upper or lower sides of the first heater wire portion. The first heater wire portion includes linear portions horizontally spaced apart from each other and extending in the up-down direction and fold-back portions each connecting ends of adjacent ones of the linear portions such that all the linear portions are connected into one. The fold-back portions include a fold-back portion adjacent to the second heater wire portion. An interval of the narrowest part between the second heater wire portion and the fold-back portion adjacent to the second heater wire portions is set to between 2 mm and 7 mm, inclusive.

### FIELD

The present disclosure relates to a vehicle exterior component which is attached to an exterior part of a vehicle equipped with a millimeter wave radar device and which permits the passage of millimeter waves transmitted from the millimeter wave radar device.

### DESCRIPTION OF RELATED ART

In vehicles equipped with a millimeter wave radar device, the millimeter wave radar device transmits millimeter waves toward the outside of the vehicle. The millimeter waves that have struck and have been reflected by an object outside the vehicle including, for example, a vehicle leading that vehicle and pedestrians, are received by the millimeter wave radar device. Using the transmitted and received millimeter waves, the millimeter wave radar device recognizes the object and detects the distance between the vehicle and the object, the relative speed, and the like.

The vehicle includes a vehicle exterior component (e.g., a millimeter wave transmissive cover) in front of the millimeter wave radar device in a direction in which millimeter waves are transmitted. The vehicle exterior component includes a decoration body that permits the passage of millimeter waves.

When ice and snow adhere to the vehicle exterior component, millimeter waves are attenuated. This attenuation lowers the detection performance of the millimeter wave radar device using millimeter waves. To solve this problem, the vehicle exterior component may additionally include a snow-melting function. For example, as shown in FIG. 4, a vehicle exterior component 50 disclosed in Japanese Laid-Open Patent Publication No. 2021-18060 includes a metal heater wire 52. The heater wire 52 is located on, for example, a rear surface of a decoration body 51.

The heater wire 52 includes a first heater wire portion 53 and a second heater wire portion 56. The second heater wire portion 56 extends in the horizontal direction on the lower side of the first heater wire portion 53. and is connected in series to the first heater wire portion 53. The first heater wire portion 53 includes linear portions 54 and fold-back portions 55. The linear portions 54 are spaced apart from each other in the horizontal direction and extend in the up-down direction. The fold-back portions 55 each connect ends of adjacent ones of the linear portions 54 such that all the linear portions 54 are connected into one.

In the vehicle exterior component 50, the heater wire 52 generates heat when energized. Thus, even if ice and snow adhere to the vehicle exterior component 50, the heat generated by the heater wire 52 melts the ice and snow. This prevents millimeter waves from being attenuated due to the adhesion of the ice and snow.

When millimeter waves are applied to the metal heater wire 52, the millimeter waves are reflected. This reflection lowers the ability of millimeter waves to pass through the vehicle exterior component 50. Thus, if the millimeter wave radar device transmits millimeter waves so as to vibrate in the horizontal direction, the passage of the millimeter waves is hindered by a portion of the heater wire 52 that extends in the horizontal direction to a larger degree than by a portion that extends in another direction (e.g., up-down direction). Particularly, the second heater wire portion 56 extends in the horizontal direction, and thus hinders the passage of the millimeter waves to a relatively large degree. The above literature fails to disclose limiting a decrease in the ability of millimeter waves to pass that results from the heater wire 52. Accordingly, there is room for improvement in this respect in the vehicle exterior component 50 disclosed in the above literature.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A vehicle exterior component that solves the problem is configured to be attached to an exterior part of a vehicle equipped with a millimeter wave radar device that transmits millimeter waves so as to vibrate in a horizontal direction. The vehicle exterior component includes a decoration body configured to be arranged at a portion in front of the millimeter wave radar device in a direction in which the millimeter waves are transmitted. The decoration body permits passage of the millimeter waves. The vehicle exterior component includes a metal heater wire arranged on the decoration body. The heater wire generate heat when energized. The heater wire includes a first heater wire portion arranged inside a passage region for the millimeter waves in an up-down direction and a second heater wire portion arranged outside the passage region. The second heater wire portion extends in the horizontal direction on at least one of an upper side or a lower side of the first heater wire portion. The second heater wire portion is connected in series to the first heater wire portion. The first heater wire portion includes linear portions spaced apart from each other in the horizontal direction and extending in the up-down direction and fold-back portions each connecting ends of adjacent ones of the linear portions such that all the linear portions are connected into one. The fold-back portions include a fold-back portion adjacent to the second heater wire portion. An interval of the narrowest part between the second heater wire portion and the fold-back portion adjacent to the second heater wire portions is set to between 2 mm and 7 mm, inclusive.

Other features and aspects will be apparent from the following detailed description, the drawings, and the claims.

### BRIEF DESCRIPTION OF DRAWINGS

FIG. 1 is a cross-sectional side view illustrating the positional relationship between an exterior part, a millimeter wave transmissive cover, a millimeter wave radar device, a passage region for millimeter waves, and the like according to an embodiment.

FIG. 2 is a rear view illustrating the positional relationship between the decoration body, the main section of the heater wire, the passage region for millimeter waves, and the like in the embodiment.

FIG. 3 is a graph illustrating the relationship between the interval (pitch) between adjacent ones of the linear portions and the attenuation amount (loss) of millimeter waves in the embodiment.

FIG. 4 is a rear view showing how the heater wire is arranged in a conventional vehicle exterior component.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are swell known to one of ordinary skill in the art may be omitted.

Exemplary embodiments may have different forms, and are not limited to the examples described. However, the examples described are thorough and complete, and convey the full scope of the disclosure to one of ordinary skill in the art

In this specification, “at least one of A and B” should be understood to mean “only A, only B, or both A and B.”

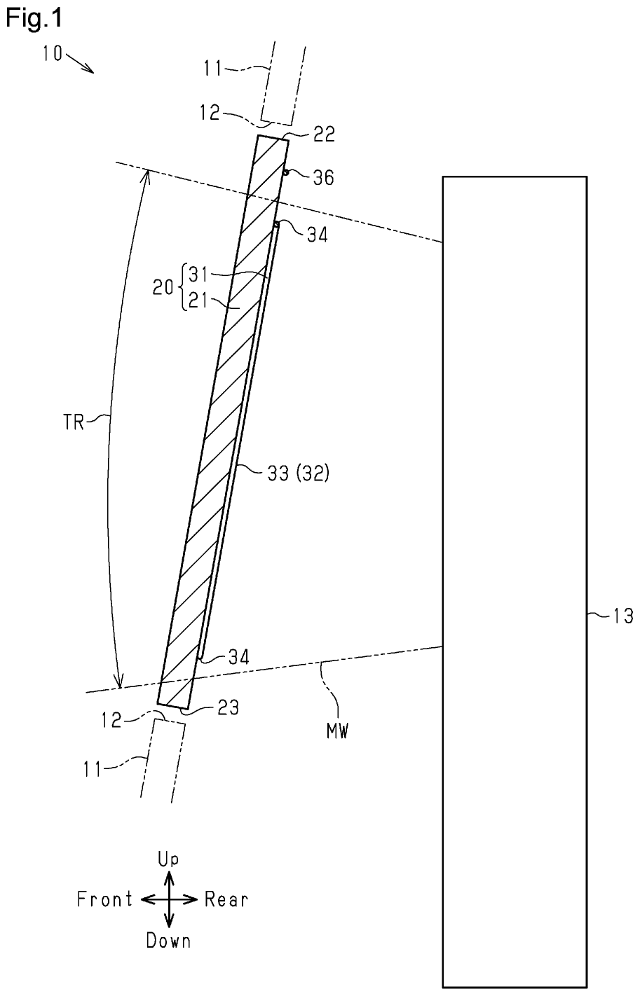

A vehicle exterior component applied to a millimeter wave transmissive cover 20 according to an embodiment will now be described with reference to FIGS. 1 to 3.

In the following description, the direction in which a vehicle 10 travels forward will be referred to as the front, and the reverse direction will be referred to as the rear. The up-down direction refers to the up-down direction of the vehicle 10, and the left-right direction refers to the width direction of the vehicle 10 that coincides with the left-right direction when the vehicle 10 travels forward.

As shown by the broken lines in FIG. 1, a front grill, a front bumper, and the like are coupled to a front part of the vehicle 10 as part of an exterior part 11. A front-monitoring millimeter wave radar device 13 is disposed between the exterior part 11 and a vehicle body (not shown). The millimeter wave radar device 13 is configured to transmit millimeter waves MW (electromagnetic waves) toward the front at the outside of the vehicle 10 and receive the millimeter waves that have struck and have been reflected by an object outside of the vehicle 10. The millimeter wave radar device 13 transmits the millimeter waves MW so as to vibrate in the horizontal direction, in other words, so as to vibrate on a horizontal plane of polarization.

In the present embodiment, as described above, the direction in which the millimeter wave radar device 13 transmits the millimeter waves MW corresponds to a direction from the rear toward the front of the vehicle 10. The front in the transmission direction of the millimeter waves MW substantially matches the front of the vehicle 10. The rear in the transmission direction substantially matches the rear of the vehicle 10. Thus, the front in the transmission direction of the millimeter waves MW is hereinafter simply referred to as “frontward” or “front,” and the rear in the transmission direction is hereinafter simply referred to as “rearward” or “rear.”

The portion of the exterior part 11 in front of the millimeter wave radar device 13 is slightly inclined with respect to the vertical plane such that the upper section of that portion becomes closer to the rear. A window 12 opens at that portion of the exterior part 11. The millimeter wave transmissive cover 20 of the present embodiment is fitted into the window 12 such that the window 12 is slightly inclined rearward in correspondence with the inclination of the exterior part 11. When at least the periphery of the window 12 in the exterior part 11 is parallel to the vertical plane, that is, When the periphery is not inclined, the millimeter wave transmissive cover 20 may he arranged upright along the vertical plane.

The millimeter wave transmissive cover 20 includes a decoration body 21 and a heater wire 31. The members of the millimeter wave transmissive cover 20 will now be described.

### Decoration Body 21

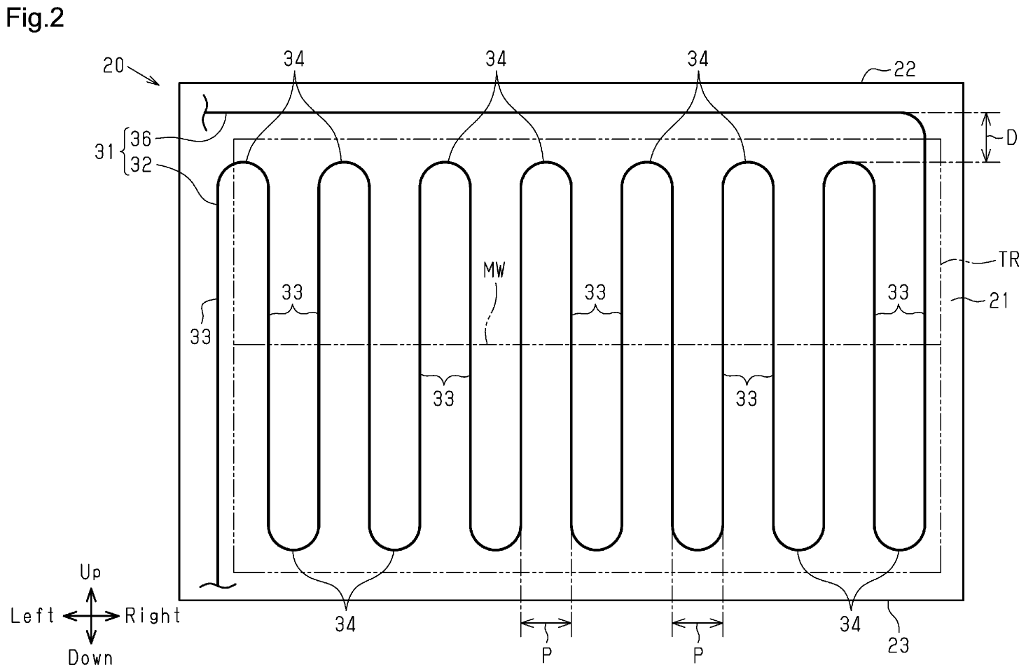

The decoration body 21 is a part of the skeleton frame of the millimeter wave transmissive cover 20. The decoration body 21 functions to decorate the vehicle 10. The decoration body 21 has the shape of a plate in which its thickness direction corresponds to the front-rear direction. As shown in FIG. 2, as viewed in the front-rear direction, the decoration body 21 has an elongated rectangular outer shape in which its dimension is greater in the horizontal direction (left-right direction) than in the up-down direction. In the present embodiment, the entire upper edge 22 and the entire lower edge 23 of the decoration body 21 extend in the horizontal direction. The upper edge 22 and the lower edge 23 may be slightly inclined (may be inclined by several degrees) with respect to the horizontal plane.

The decoration body 21 may include a single layer that permits the passage of millimeter waves MW. Alternatively, the decoration body 21 may include a layer structure in which layers are laminated in the front-rear direction. The layers each permit the passage of millimeter waves MW. The layers may include a decorative layer.

As shown by the long dashed double-short dashed line in FIG. 2, part of a region inward of the outer edge of the decoration body 21 is a passage region TR for millimeter waves MW transmitted from the millimeter wave radar device 11. The outer edge includes the upper edge 22 and the lower edge 23.

### Heater Wire 31

The heater wire 31, which is shown in FIGS. 1 and 2, is used to add a snow-melting function to the millimeter wave transmissive cover 20. The heater wire 31 is made of a metal material e.g., copper) that generates heat when energized. The heater wire 31 has an elongated shape. The heater wire 31 can be supplied with power from an external device. The heater wire 31 is arranged on the rear surface of the decoration body 21. The heater wire 31 may be arranged on the front surface of the decoration body 21. When the decoration body 21 has a layer structure, the heater wire 31 may be arranged between layers adjacent to each other in the front-rear direction.

The heater wire 31 includes a first heater portion 32 and a second heater wire portion 36 that are connected in series to each other.

### First Heater Wire Portion 32

The first heater wire portion 32 is arranged inside the passage region TR at least in the up-down direction. The entire first heater wire portion 32 may be arranged inside the passage region TR in the horizontal direction. Alternatively, one or both ends of the first heater wire portion 32 in the horizontal direction may be arranged outside the passage region TR. FIG. 2 shows an example in which the left end of the first heater wire portion 32 (a linear portion 33 at the left end) is arranged outside the passage region TR and the right end (a linear portion 33 at the right end) is arranged inside the passage region TR.

The first heater wire portion 32 includes linear portions 33 and fold-back portions 34. The linear portions 33 are spaced apart from each other in the horizontal direction (left-right direction) and extend parallel to each other in the up-down direction. The up-down direction is a direction in which the linear portions 33 extend when the millimeter wave transmissive cover 20 is viewed in the front-rear direction. The linear portions 33 are inclined rearward in the front-rear direction in correspondence with the decoration body 21, that is, slightly inclined such that the upper section of each linear portion 33 becomes closer to the rear. The upper ends of the linear portions 33 other than the rightmost linear portion 33 are located at the same height. The lower ends of the linear portions 33 other than the leftmost linear portion 33 are located at the same height.

The interval between adjacent ones of the linear portions 33 is set to the same value in any combination of the adjacent ones of the linear portions 33. Thus, this interval is referred to as a pitch P. In the present embodiment, the pitch P is set to a value of 7 mm or less.

The fold-back portions 34 each connect the ends of adjacent ones of the linear portions 33 such that all the linear portions 33 are connected into one. Thus, the first heater wire portion 32 is shaped so as to extend in a serpentine manner like a wave advancing in the horizontal direction while vibrating in the up-down direction. The upper fold-back portions 34 are located at the same height. The lower fold-back portions 34 are located at the same height.

Each fold-back portion 34 bulges from a section between adjacent ones of the linear portions 33. Specifically, the upper fold-back portions 34 each connecting the upper ends of adjacent ones of the linear portions 33 bulge upward. The lower fold-back portions 34 each connecting the lower ends of adjacent ones of the linear portions 33 bulge downward. The upwardly-bulging fold-back portions 34 and the downwardly-bulging fold-back portions 34 are alternately arranged in the horizontal direction. Each fold-back portion 34 has a semicircular shape having the same size as the pitch P. In this case, the fold-back portion 34 has a diameter of 7 mm or less.

### Second Heater Wire Portion 36

The second heater wire portion 36 extends in the horizontal direction along the upper edge 22 outside the passage region TR and on the upper side of the first heater wire portion 32. The right end of the second heater wire portion 36 is located on the upper side of the rightmost linear portion 33 and connected to the upper end of that linear portion 33. The left end of the second heater wire portion 36 is located in the vicinity of the left side of the leftmost linear portion 33. The left end of the second heater wire portion 36 may be connected to the upper end of the leftmost linear portion 33.

The upper ones of the fold-back portions 34 are adjacent to the second heater wire portion 36. That is, the fold-back portions 34 include fold-back portions 34 adjacent to the second heater wire portion 36. The interval of the narrowest part between the second heater wire portion 36 and the upper fold-back portions 34 adjacent to the second heater wire portion 36, that is, an interval D between the second heater wire portion 36 and the top of each upper fold-back portion 34 is set to between 2 mm and 7 mm, inclusive.

The operation of the present embodiment will now be described. The advantages resulting from the operation will also be described.

### (1) Ability of Millimeter Waves MW to Pass Through

In FIG. 1, when millimeter waves MW are transmitted from the millimeter wave radar device 13, the millimeter waves MW pass through the millimeter wave transmissive cover 20 frontward from the rear. The passed millimeter waves MW are reflected by an object outside the vehicle including, for example, a vehicle leading that vehicle and pedestrians. Some of the reflected millimeter waves pass through the millimeter wave transmissive cover 20 frontward from the rear and are then received by the millimeter wave radar device 13. Based on the transmitted millimeter waves MW and the received millimeter waves, the millimeter wave radar device 13 recognizes the object and detects, for example, the distance between the vehicle 10 and the object, the relative speed, and the like.

When millimeter waves MW are applied to the metal heater wire 31, the millimeter waves MW are reflected. This reflection produces loss, and thus lowers the ability of the millimeter waves MW to pass. Also, millimeter waves MW are transmitted from the millimeter wave radar device 13 so as to vibrate in the horizontal direction. Thus, the passage of the millimeter waves MW is hindered by a portion of the heater wire 31 that extends in the horizontal direction to a larger degree than a portion that extends in another direction (e.g., up-down direction).

(1-1) The second heater wire portion 36 of the heater wire 31 extends in the horizontal direction. The second heater wire portion 36 has a length substantially equal to the dimension of the first heater wire portion 32 in the horizontal direction. Thus, when millimeter waves MW are applied, the second heater wire portion 36 hinders the passage of the millimeter waves MW to a larger degree than other portions of the heater wire 31.

In the present embodiment, the second heater wire portion 36 is arranged outside the passage region TR for millimeter waves MW. Thus, if the variations in dimension of the millimeter wave transmissive cover 20 are negligibly small and the millimeter wave transmissive cover 20 is not moved relative to the millimeter wave radar device 13 in the up-down direction regardless of vibration or the like of the vehicle 10, the millimeter waves MW are not applied to the second heater wire portion 36 or are not easily applied to the second heater wire portion 36. This limits situations in which the passage of the millimeter waves MW is hindered by the second heater wire portion 36. Accordingly, the present embodiment limits a decrease in the ability of the millimeter waves MW to pass caused by the second heater wire portion 36.

(1-2) The interval D between the fold-back portions 34 and the second heater wire portion 36 is 2 mm or greater even at the narrowest part. This allows the passage region TR to be set such that millimeter waves MW are not applied to the second heater wire portion 36 regardless of the variations in the dimension of the millimeter wave transmissive cover 20, up-down movement of the millimeter wave transmissive cover 20 that results from vibration of the vehicle 10, and the like. In other words, the passage region TR is set such that the second heater wire portion 36 is not located inside the passage region TR for the millimeter waves MW even if the variations in dimension, up-down vibration, and the like occur.

(1-3) The fold-back portions 34 of the first heater wire portion 32 each include a part extending in the horizontal direction. However, the length of this part in the horizontal direction is shorter than the length of the second heater wire portion 36 in the horizontal direction. Thus, the fold-back portions 34 hinder the passage of millimeter waves MW to a smaller extent than the second heater wire portion 36.

In addition, each fold-hack portion 34 is curved. This further lowers the degree to which the fold-back portion 34 hinders the passage of the millimeter waves MW.

(1-4) Particularly, in the present embodiment, each fold-hack portion 34 has a semicircular shape having the same diameter as the pitch P. Thus, the length of the part of the fold-back portion 34 extending in the horizontal direction is the smallest possible length. That is, when the diameter of each fold-back portion 34 is smaller than the interval (pitch P) between adjacent ones of the linear portions 33, that fold-back portion 34 has a linear part extending in the horizontal direction. In contrast, when the diameter is equal to the pitch P, the fold-back portion 34 has an arcuate shape and thus includes no linear part extending in the horizontal direction.

Thus, the part of the fold-back portion 34 extending in the horizontal direction hinders the passage of the millimeter waves MW to the smallest possible degree. Accordingly, the present embodiment limits a decrease in the ability of the millimeter waves MW to pass caused by the fold-back portions 34.

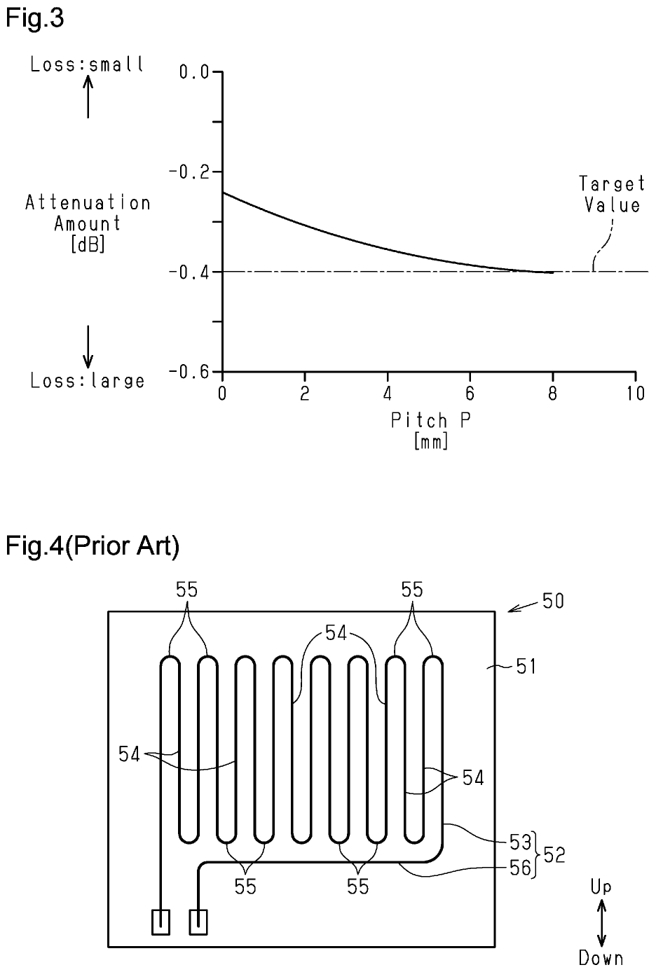

(1-5) Measurement was performed for the amount (attenuation amount) of millimeter waves MW attenuated during passage through the passage region TR of the millimeter wave transmissive cover 20, while changing the pitch P (interval) between adjacent ones of the linear portions 33 of the first heater wire portion 32. As a result, the relationship shown in FIG. 3 was observed between the pitch P and the attenuation amount. The fold-back portions 34 are located in the passage region TR. Thus, the attenuation amount is affected by the fold-back portions 34.

FIG. 3 shows that the loss produced by the passage of the millimeter waves MW through the millimeter wave transmissive cover 20 becomes smaller and the attenuation amount becomes smaller toward the upper region. FIG. 3 also shows that the loss becomes larger and the attenuation amount becomes larger toward the lower region.

FIG. 3 indicates that the attenuation (loss) decreases as the pitch P decreases. This is because the parts of the fold-back portions 34 that extend in the horizontal direction to hinder the passage of the millimeter waves MW are shortened.

As shown in FIG. 3, when the target value of the attenuation amount is set to, for example, −0.4 dB and the pitch P is 7 mm or less, the attenuation amount becomes smaller than the target value, which is preferred.

In the present embodiment, the pitch P is set to 7 mm or less. Thus, the attenuation amount is made smaller than the target value. In other words, the attenuation amount (loss) of the millimeter waves MW are within an allowable range.

(2) Snow-Melting Function

When ice and snow adhere to the millimeter wave transmissive cover 20, millimeter waves MW are attenuated. This lowers the detection performance of the millimeter wave radar device 13. In this case, the heater wire 31 is supplied with power from an external device.

(2-1) Referring to FIGS. 1 and 2, the heater wire 31 that has been supplied with power generate heat when energized. Some of the heat generated by the heater wire 31 is transferred to the surroundings of the heater wire 31 in the millimeter wave transmissive cover 20. This heat melts ice and snow, and thus prevents the detection performance of the millimeter wave radar device 13 from being lowered due to the adhesion of ice and snow.

(2-2) In the present embodiment, the interval D is 7 mm at the maximum. This prevents situations in which the interval D becomes excessively wide relative to the pitch P (interval), which is set to 7 mm or less. Thus, a region that should be heated is evenly heated. This limits a decrease in the heating performance caused by uneven heating of that region.

(2-3) In the present embodiment, the second heater wire portion 36 extends in the horizontal direction along the upper edge 22 on the upper side of the first heater wire portion 32. Thus, even if ice and snow adhere to a portion of the millimeter wave transmissive cover 20 located higher than the first heater wire portion 32, the ice and snow are melted by the heat generated by the second heater wire portion 36.

Further, ice and snow may adhere to the upper side of the parts between adjacent ones of the fold-back portions 34. In such a case, even if the ice and snow are not inched by the heat generated by the first heater wire portion 32, the ice and snow are melted by the heat generated by the second heater wire portion 36.

(2-4) In the present embodiment, as described above, the interval D is set to between 2 mm and 7 mm, inclusive. This brings the upper fold-back portions 34 toward the second heater wire portion 36. Thus, as compared with when the interval D is greater than the 7 mm, the heater wire 31 melts snow in a wider region of the millimeter wave transmissive cover 20.

The above embodiment may be modified as follows. The above embodiment and the following modifications can be combined as long as the combined modifications remain technically consistent with each other.

### Modifications Related to Decoration Body 21

The outer shape of the decoration body 21, as viewed in the front-rear direction, may be changed to a shape different from a quadrangle in which the upper edge 22 and the lower edge 23 extend in the horizontal direction.

When the outer shape of the decoration body 21, as viewed in the front-rear direction, is a quadrangle in which the upper edge 22 and the lower edge 23 extend in the horizontal direction, the outer shape may be changed to a shape different from that of the embodiment. The outer shape may be changed to, for example, a vertically long rectangle, a square, a trapezoid, or a parallelogram. Further, the corners of the quadrangle may be arcuate.

The entire upper edge 22 and the entire lower edge 23 of the decoration body 21 may extend linearly in the horizontal direction. Instead, part of the upper edge 22 and the lower edge 23 may have a portion extending in a direction different from the horizontal direction.

### Modifications Related to Heater Wire 31

The diameter of each fold-hack portion 34 may be set to he less than the pitch P. In this case, the fold-back portion 34 includes a linear part that extends in the horizontal direction. The length of the linear part s preferably set such that the influence on the ability of millimeter waves MW to pass is a negligibly small extent.

The pitch P may be set to be uniform among multiple combinations of adjacent ones of the linear portions 33 as in the embodiment described above. Alternatively, the pitch P may be set to be different among the combinations.

The second heater wire portion 36 may be located on the lower side of the first heater wire portion 32 instead of being located on the upper side.

The second heater wire portion 36 may be located on the upper and lower sides of the first heater wire portion 32. In this case, one end of the upper second heater wire portion 36 is connected to the upper end of the rightmost or leftmost linear portion 33 of the first heater wire portion 32. One end of the lower second heater wire portion 36 is connected to the lower end of the leftmost or rightmost linear portion 33 of the first heater wire portion 32.

The length of the second heater wire portion 36 does not necessarily have to be substantially equal to the dimension of the first heater wire portion 32 in the horizontal direction, and may be set to be shorter or longer than the dimension.

The heater wire 31 may be a part of a heater sheet. In this case, the heater sheet includes a sheet base formed of a resin material or the like and a heater wire 31 arranged above the sheet base.

The heater wire 31 may be formed, for a foil (e.g., copper or silver) bonded to a sheet base, by performing a photolithography process and a process that uses an optical mask and then removing an unnecessary part.

Alternatively, the heater wire 31 may be formed by patterning, through etching, a metal (e.g., copper or silver) coat that is formed on the sheet base through plating.

### Other Modifications

The millimeter wave radar device 13 does not have to be a front-monitoring device. Instead, the millimeter wave radar device 13 may be a rear monitoring device, a side monitoring device for the front part, or a side monitoring device for the rear part. In this case, the direction in which the millimeter wave radar device 13 is oriented, that is, the direction in which millimeter waves MW are transmitted, is changed to a direction different from that in the above embodiment. In any of the modifications, the vehicle exterior component is located in front of the millimeter wave radar device 13 in the direction in which millimeter waves MW are transmitted.

The above vehicle exterior component is applicable not only to the millimeter wave transmissive cover 20 but also to a vehicle exterior component such as an emblem, an ornament or a mark that functions to decorate the vehicle 10.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A vehicle exterior component configured to he attached to an exterior part of a vehicle equipped with a. millimeter wave radar device that transmits millimeter waves so as to vibrate in a horizontal direction, the vehicle exterior component comprising:
a decoration body configured to be arranged at a portion in front of the millimeter wave radar device in a direction in which the millimeter waves are transmitted, the decoration body permitting passage of the millimeter waves; and
a metal heater wire arranged on the decoration body, the heater wire generating heat when energized, wherein
the heater wire includes:
a first heater wire portion arranged inside a passage region for the millimeter waves in an up-down direction; and
a second heater wire portion arranged outside the passage region, the second heater wire portion extending in the horizontal direction on at least one of an upper side or a lower side of the first heater wire portion, and the second heater wire portion connected in series to the first heater wire portion,
the first heater wire portion includes:
linear portions spaced apart from each other in the horizontal direction and extending in the up-down direction; and
fold-back portions each connecting ends of adjacent ones of the linear portions such that all the linear portions are connected into one,
the fold-back portions include a fold-back portion adjacent to the second heater wire portion, and
an interval of the narrowest part between the second heater wire portion and the fold-back portion adjacent to the second heater wire portions is set to between 2 mm and 7 mm, inclusive.

2. The vehicle exterior component according to claim 1, wherein each of the fold-back portions has a semicircular shape with a diameter that is equal to an interval between the adjacent ones of the linear portions.

3. The vehicle exterior component according to claim 1, wherein an interval between the adjacent ones of the linear portions is set to 7 mm or less.
